(19) United States
(12) Patent Application Publication
(10) Pub. No.: US 2011/0148118 A1
(43) Pub. Date: Jun. 23, 2011

(54) Low speed hydro powered electric generating system

(75) Inventors: Keith G. Burnett, Seminole, FL (US); Clark H. Scherer, JR., Gulfport, FL (US)

(73) Assignee: Hiawatha Energy Inc.

(21) Appl. No.: 12/653,882

(22) Filed: Dec. 18, 2009

(51) Int. Cl. F03B 13/10

(52) U.S. Cl. 290/54

(57) ABSTRACT

A low speed hydro powered electric generating system capable of harnessing the flow of rivers, ocean currents, and tides that meets the requirements of electric power companies for base load generating equipment considering availability of rated power on demand, quality of power, safety, and overall capital cost. Water will be sucked across a parallel axis radial turbine spinning inside a central water tube by a downstream exit cowling of larger cross sectional area than the turbine. The suction created from the downstream exit cowling applied back upstream through converging plates sufficiently accelerates the velocity of the water to economically produce renewable electric energy.

### BACKGROUND OF THE INVENTION

1. Field of the Invention

The filed of this invention is the generation of electricity by renewable resources.

2. Description of the Related Art

Water flowing in a river typically runs about 1.5 meters per second or 3 mph. Momentum considerations dictate that the blade area of a turbine system would have to be impractically large to extract useful power from the movement of water in a river at that velocity. Due to the attractiveness of a continually flowing river as a source of electric power, considerable work has been done recently in this field. In U.S. Pat. No. 6,765,308 Kazanjian 7/2004 discloses a simple turbine in a water stream which fails in a river application due to an inability to generate useful amounts of power from the slow moving water. Much of the useful work relative to water moving at the velocities normal to rivers focuses on two different areas. One focus is to raise water pressure—U.S. Pat. No. 7,564,144 Srybnik et al 12/2008, and the other is to raise velocity—U.S. Pat. No. 7,456,514 Ahmad 11/2008. Others attempting to raise velocity through venturiis include U.S. Pat. No. 7,084,521 Martin 78/2006 and U.S. Pat. No. 7,116,005 Corcoran, III.

The system described by Srybnik will actually function in tidal systems where flow goes intermittently in both directions. It functions by increasing water pressure across a Pelton Wheel which is a distinctly different system than the Low Speed Hydro Powered Electrical Generating System.

The venturii systems described by Martin and Corcoran also function according to different principals than those addressed in this application.

The system described by Ahmad uses upstream plates to channel a larger cross section of water through an acceleration zone upstream from the generator section thence across a smaller cross axis turbine substantially increasing the velocity across the turbine. Downstream plates are then used as a deceleration zone to return the water to the river at its normal velocity, but these downstream plates contribute nothing to the power of the system. They do allow the water to be reintroduced to the river at a velocity that does not produce a backpressure and interfere with upstream acceleration zones. Ahmad discloses that this system results in an increase in water head upriver. Although not specifically disclosed by Ahmad, this is due to the momentum energy contained in a stream of faster moving water. Energy in any moving fluid is a function of the cube of the velocity of that fluid, so when the water is accelerated, the energy content is increased and that energy has to come from somewhere. The total momentum energy of a moving stream of fluid=½×(density)×(velocity) cubed×(area). For energy in watts, density is in kg per cubic meter, velocity is in meters per second and area is in square meters. Considering that the density of water=1000 kg per cubic meter, the total momentum energy of a river that is 20 meters deep and 80 meters wide and moving at 1.5 meters per second is:

½×(1000)×((1.5 cubed))×(1600 in square meters)=2,700,000 watts.

Assuming a system where the cross sectional area of the water constricting system is 18 square meters considering the energy content of the fluid entering into and moving through the system alone and with no contribution from the energy of the water flowing around the system, the maximum attainable velocity would be:

Velocity=cube root of ((watts/(½×1000×area))=6.68 meters per second. The maximum acceleration ratio attainable form the momentum of the water moving through the system alone is 6.68/1.5=4.5:1. Relating that ratio back to the 18 square meters of the cross sectional area of the water constricting system, any constriction greater than 4.5:1 creates a backpressure upstream of the water constricting system.

Any higher velocities attained by Ahmad do so by drawing energy from the river upstream via the mechanism of the river itself operating against that backpressure. Drawing this energy tends to slow the river but the water further upstream does not slow and piles up. The result is an increase in the level of the river upstream, and the energy for accelerating the water actually comes from the increased river head. The greater the acceleration of the water, the greater this rise in level will be. Accelerating water to the super-critical speeds envisioned by Ahmad will either require a very large river relative to the size of the turbine or will result in large increases in river level which may prove socially impractical in many applications.

In all alternative/renewable energy systems there are two issues present. The first issue is capital cost. Electric power companies are required to keep their costs as low as practically possible by the Public Service Commissions that regulate them and the capital cost of their generating equipment is a major part of their costs. Financial justification based on return on capital for the fuel costs determining the actual value of renewable resource equipment vs. the fossil fueled equipment can easily be developed. The initial problem with all current renewable resource electric generating systems is that the return offered by eliminating the fuel cost has been insufficient to justify the additional expense.

The second issue—indicative of wind and solar—is the reliability of the supply to meet a demand. For wind and solar devices to be a part of an electric power company's base load generating system, energy storage systems have to be added so that customers demand can be met as needed. To date, these energy storage systems are too expensive to be practical when added into the return on capital cost considerations of the first issue. The ability to deliver rated power on demand, regardless of the weather, is well handled by river, ocean currents, and tides as these systems flow predictably all year long, removing the need for large energy storage devices, yet delivering a reliable supply of power which an electric company can consider part of its base load generating system.

These two driving issues are the root cause of the low adoption rate of renewable energy technologies. Therefore any improvements that offer capital cost savings, and rated power on demand are extremely significant.

Additionally, the utilization of solid state inverter technology for co-generation applications has always posed a problem for electric utility companies. Inverters are very good about delivering the shape and frequency of sine wave required, but if the timing of the peak of the sine wave of the inverter does not match with the peak on the grid, various weird harmonics and resonances can occur that can cause problems for their customers. Solid State Inverter manufacturers have added timing technology to their inverters that sense and match the timing on the grid, but the reliability of these devices is critical and presently there is no capability to monitor or control this critical parameter. This situation is not comfortable for electric power companies.

### SUMMARY OF THE INVENTION

A low speed hydro powered electric generating system is defined as a system that takes the energy contained as momentum in the moving water currents, using the energy of the water moving around the system to create a downstream negative pressure or suction applied back into the system via an exit cowling to accelerate a portion of the water across a radial turbine spinning inside a central water tube and via the spinning of this turbine, permanent magnet inductors pass across a coil producing electrical energy.

In another embodiment, the turbine is suspended by rectangular magnets which function as magnetic bearings. Magnets are located on the interior of the central water tube and the exterior of the turbine with directly opposing magnetic fields creating a radial bearing. One radial bearing system is placed at the upstream side and one is placed at the downstream side. Other magnets are located on the central water tube upstream and downstream of the turbine forming magnetic thrust bearings.

In another embodiment, a well known system of converting the DC power produced in the coils to AC power distributed by electric companies is by using an inverter bank powered by a battery bank between the electric generating coils and the inverter bank. A portion of the DC batteries are wired together in series forming a unit operating at a higher voltage. Several units of series wired batteries are placed in parallel to create redundancy. Continuity sensors are wired across the individual batteries which are monitored by a control computer. This computer is capable of sensing if continuity is no longer present alerting a remote monitor of the need for maintenance. That particular unit of batteries wired in series may be taken off line without degrading the voltage of the system. A bank of connected and coordinated DC to AC inverters is used to convert the DC power produced in the generator coils to voltage and frequency controlled AC power. Each inverter is connected to the control computer which will monitor and control the timing of the sine wave output, controlling all of them so that the timing is identical and will be reported to a remote monitor. This monitor may then use the control computer to adjust the overall sine wave timing to coordinate it with the timing of the grid. Additionally there will be a redundancy of inverters so that in the event of a malfunctioning inverter, it can be taken off line without affecting the performance of the overall system.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an isometric view of the exit cowling and central water tube.

FIG. 2A is a top view and FIG. 2B is a front view of the disclosed system with an exploded view of the tiplet, inductor, generating coil arrangement FIG. 2C and FIG. 2D.

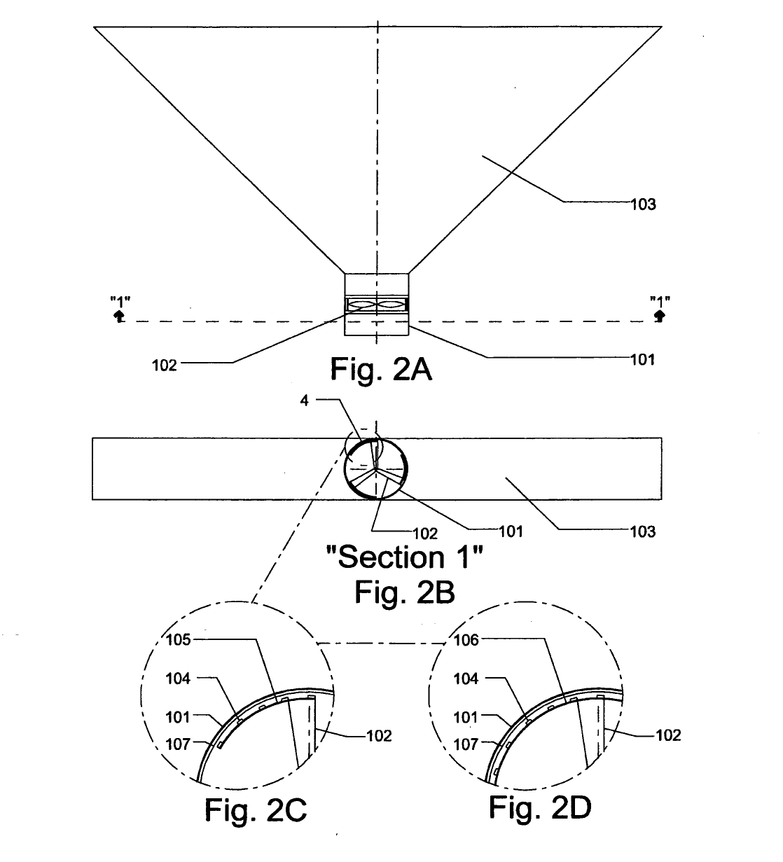

FIG. 3A is a top view and FIG. 3B is a side view of the disclosed system showing the screen barricade and how it relates to the rest of the system.

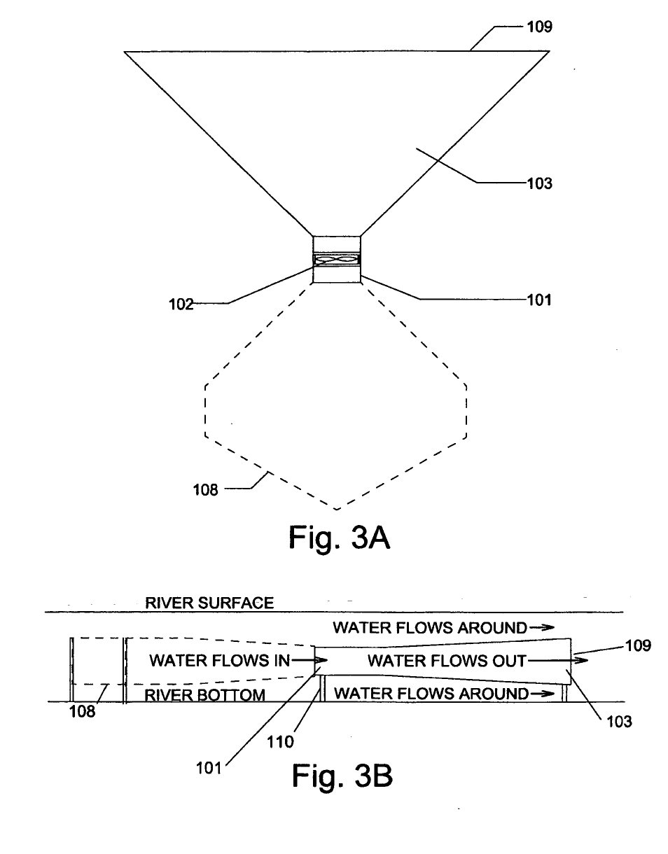

FIG. 4A is an exploded view of the turbine and the central water tube illustrating how the turbine is suspended by the permanent magnets. FIG. 4B is a section through the turbine and the central water tube further illustrating the arrangement of the permanent magnets.

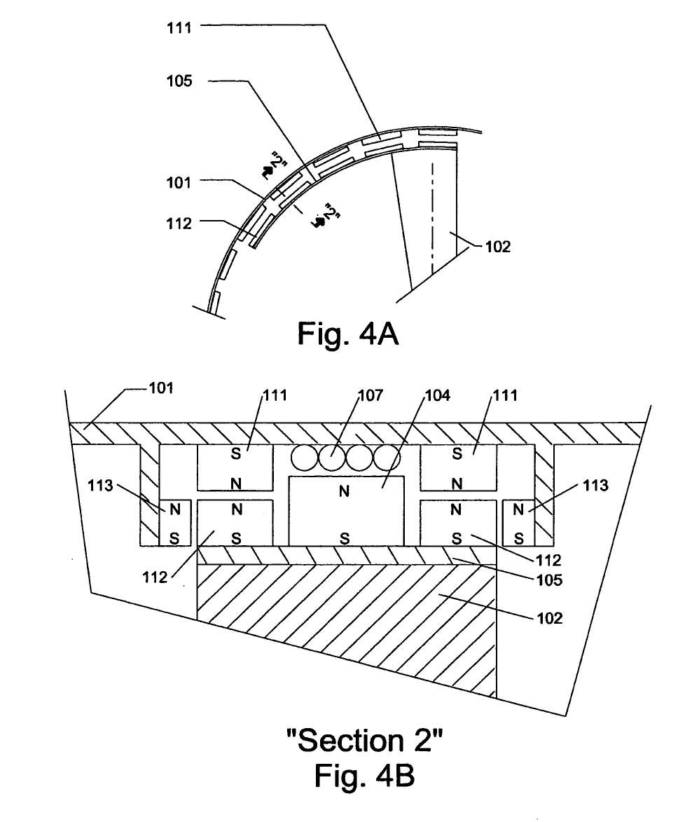

FIG. 5 is a schematic representation of the contents of the generator housing with the inverter bank embodiment.

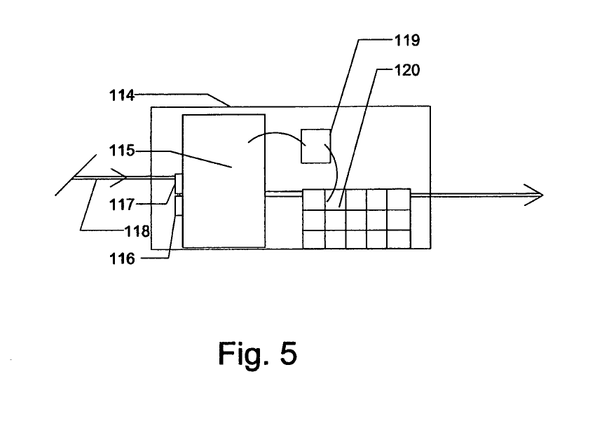

FIG. 6 is a schematic representation of the contents of the generator housing with the DC motor and AC generator embodiment.

FIG. 7 is a view of a series wired battery bank with several units wired in parallel.

FIG. 8 is a side view of the ocean current embodiment.

FIG. 9 is a side view of the tidal flow embodiment.

### DETAILED DESCRIPTION

The preferred embodiment is a 1.0 megawatt low speed hydro powered electric generating system operating in a river. The actual power that can be practically recovered from a radial turbine is about one third of the total system energy. The preferred river in cross section is 850 square meters while moving at 1.92 meters per second (4 mph) with a total momentum energy of 3.0 megawatts.

The size of the exit cowling (103) will be 2.62 meters high (8 feet)×13 meters wide (40 feet) at the exit and will extend 6.56 meters (20 feet) back from the rear of the central water passage.

The radial turbine (102) will have a ring (106) around it with an inside diameter of 1.64 meters (5 feet) and the outside diameter of 1.67 meters.

The central water passage (101) will be 1.80 meters (5.5 feet) by 3.28 meters (10 feet) in length.

The turbine (102) will have 3 hydrofoil blades.

Each blade will have a 12″ chord and 2″ maximum thickness.

The blade will twist as it moves out of the radius from 40 to 70 degrees off the axis of water flow.

Five ½″×½″×3″ rare earth bar magnets will be placed in a row parallel to the axis of water flow on a tiplet to form one inductor (104).

There will be 30 inductors (104) around the outer circumference of the ring (106).

½″×½″×3″ rare earth magnets (111, 112, 113) will be used around the periphery of the central water passage opposed by similar magnets on the tiplets to form a magnetic bearing. This assembly will be repeated at each end of the radial turbine.

There will be 30 inductors (104) 0.175 meters apart on the ring (106).

The electric generating coils (107) will be made from 750 kcmil THHN copper wire. There will be three isolated sections, each consisting of 6 complete revolutions of the central water compartment.

This preferred DC generating scheme consists of 3 series wound generator circuits.

An 8 foot×8 foot×20 foot shipping container will be used as the generator equipment housing (114).

The battery bank (115) will contain 3 parallel wired units of thirty-three 12 volt series wired truck batteries of 2400 VA storage capacity for a nominal voltage of 400 volts.

Continuity sensors (124) will be wired across the poles of each battery and connected to a control computer (119) to monitor battery conditions.

250 individual grade, single output, pure sine wave 5 KW 400 volt DC to 4800 volt AC inverters with the ability to time the sine wave to coordinate with the grid and with appropriate diagnostic circuits will be wired together to form a one megawatt inverter bank (120).

The voltage regulator solenoid system (116) will consist of three voltage regulators operating 3 solenoids (117). Voltage regulator #1, operating solenoid #1 connecting electrical generating coil section #1 will connect at 400 volts and disconnect at 410 volts. Voltage regulator #2, operating solenoid #2 connecting electrical generating coil section #2 will connect at 405 volts and disconnect at 415 volts. Voltage regulator #3, operating solenoid #3 connecting electrical generating coil section #3 will connect at 410 volts and disconnect at 420 volts.

A low speed hydro powered electric generating system takes the energy contained as momentum in the moving water currents, using the energy of the water moving around the system to create a downstream negative pressure or suction applied back into the system to accelerate a portion of the water across a turbine and via the spinning of this turbine produces electrical energy.

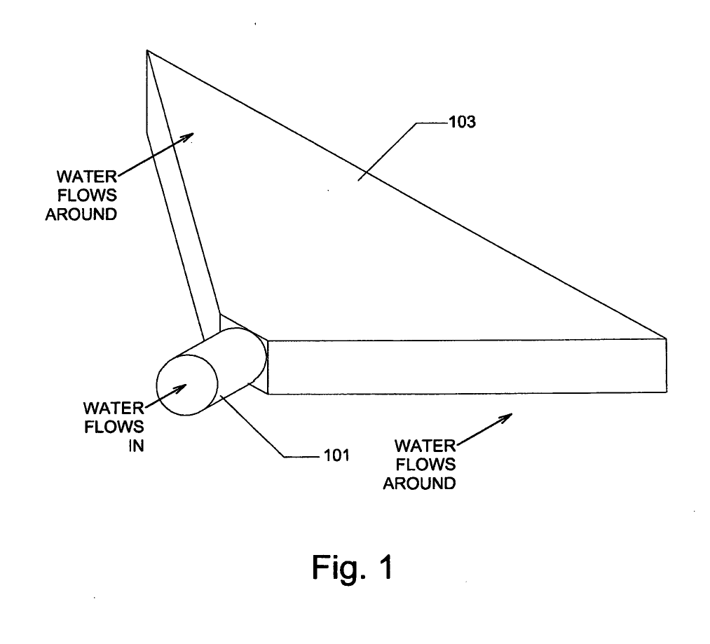

In the system described, water sucked into the system, FIG. 1, at the upstream side of the central water passage (101), passes across a parallel axis radial turbine (102) spinning the turbine and then flows into the exit cowling (103). The turbine (102) is suspended by rectangular magnets which function as magnetic bearings. Magnets are located on the interior (111) of the central water tube and the exterior (112) of the turbine with directly opposing magnetic fields creating a radial bearing. One radial bearing system is placed at the upstream side and one is placed at the downstream side. Other magnets (113) are located on the central water tube (101) upstream and downstream of the turbine (102) forming thrust bearings.

If no water is moving around the system as the water moves into the larger cross sectional area of the exit cowling, it slows down due to the ratio between the exit and the entrance areas. With 10 square feet of entrance area and water entering at 10 mph, the exit area of 100 square feet would produce an exit velocity of 1 mph. The water that is moving around the system will actually accelerate slightly due to the presence of an “obstruction.” Therefore the water moving around the system is moving significantly faster than the water moving through the system. When the faster stream moves over the slower one, a frictional layer develops and momentum energy from the faster water is transferred accelerating the slower water. This acceleration creates suction back into the exit cowling which also accelerates all of the water in the downstream exit cowling. This has the effect of decelerating the water moving around the system. However, the momentum of the water upstream effectively prevents this from happening as the water moving through the system comes to velocity equilibrium with the water moving around the system.

The exit area to entrance area ratio can be any ratio that accelerates the water across the turbine sufficiently so that useful power can be extracted. In the preferred embodiment that ratio is 15:1. If full theoretical energy transfer were to occur, the water in the central water passage would be moving 15 times faster than the water leaving the exit cowling. Due to frictional, vortex and other losses some of this energy will dissipate into the surrounding water, and not back into the water coming through the exit cowling. The result is that the water moving through the central water passage is moving approximately 10 times faster than the river itself.

The water sucked through the central water passage (101) is directed across the turbine (102), spinning it at a velocity significantly higher than that which could be achieved without the exit cowling (103), and it is the spinning of the turbine that generates the electric power. This suction could be dangerous to river life, so an upstream screen barrier (108) and a downstream barrier (109) are constructed to keep such life away. The entire system is constructed on feet (110) to keep it off the river bottom allowing the water flowing under the system to contribute to the overall energy produced.

A principal difference between the system described herein and that described by Ahmad whose upstream plates act to use the water upstream to “push” the water through an upstream acceleration zone is that in this invention the water downstream is used to “suck” it through. Engineering modeling with fluid flows indicates that downstream suction in this application is more efficient than upstream pressure.

Because the system described by Ahmad has cowlings at both ends, and the fabrication cost of these devices is high, the system described herein can be built at significantly lower cost than that of Ahmad or any other system of which we are aware.

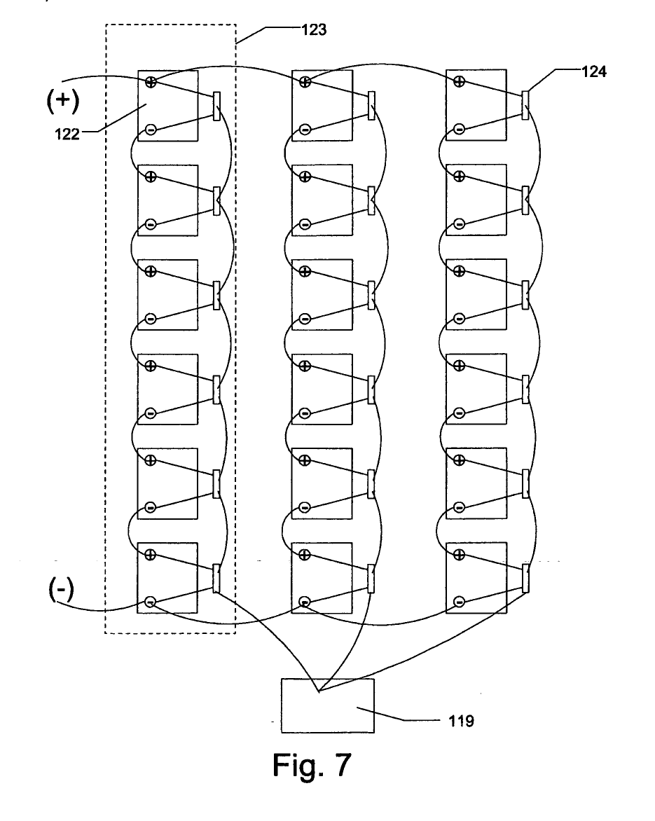

A well known system of converting rotational energy to DC current is by passing permanent magnet inductors (104) attached to a tiplet (105) or a ring (106) across a coil (107). Power in the coils is transmitted by electric cables (118) to a housing (114) which contains equipment to convert DC power to AC power. Another well known system of converting the DC power produced in the coils to AC power distributed by electric companies is by using an inverter bank (120). However this system has several important modifications which directly relate to the reliability required of base load generating equipment by electrical power companies. A battery bank (115) between the electric generating coils (107) and the inverter bank (120) is used so that the turbine (102) does not have to be throttled to deliver constant voltage. A portion of the DC batteries are wired together in series forming a unit (123) operating at a higher voltage than that of the batteries themselves allowing the wiring of the generator coil (107) to be accomplished with smaller windings. Several units of series wired batteries are placed in parallel to create redundancy shown in FIG. 7 so that the failure of any particular battery does not degrade the voltage of the overall battery bank and adversely affect performance. Continuity sensors are wired across the individual batteries which are monitored by the control computer. This computer is capable of sensing if continuity is no longer present alerting a remote monitor of the need for maintenance. That particular unit of batteries wired in series may be taken off line without degrading the voltage of the system. A monitoring system of this nature is an essential component of a battery based system designed for reliability required by electric power companies.

A bank of connected and coordinated DC to AC inverters (120) is used to convert the DC power produced in the generator coils to voltage and frequency controlled AC power. Each inverter will be connected to a control computer (119) which will monitor and control the timing of the sine wave output, controlling all of them so that the timing is identical and will be reported to a remote monitor. This monitor may then use the control computer (119) to adjust the overall sine wave timing to coordinate it with the timing of the grid. Additionally there will be a redundancy of inverters so that in the event of a malfunctioning inverter, it can be taken off line without affecting the performance of the overall system.

The combination of battery unit redundancy, battery continuity monitoring, inverter redundancy and inverter monitoring produces a system that is reliable, economical, able to be monitored and controlled, meeting the requirements of electric utility companies for base load power producing equipment.

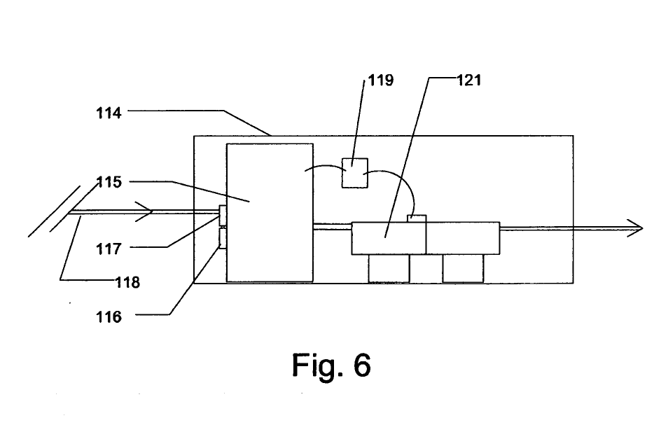

In an alternative embodiment FIG. 6, a well know system of converting DC power produced in the coils into AC power distributed by electric companies is by using a DC Motor/AC Generator set (121) which may be used in place of the inverter bank.

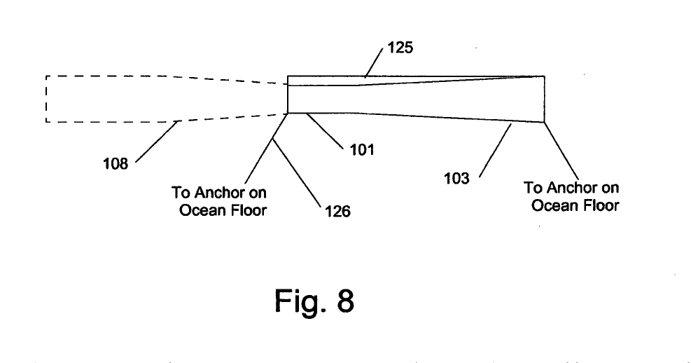

In an alternative embodiment, FIG. 8, the system may be fabricated with floatation (125) and suspended in ocean currents such as the Gulf Stream, and anchored to the bottom with anchoring cables (126) which also serve to suspend the system at the desired level.

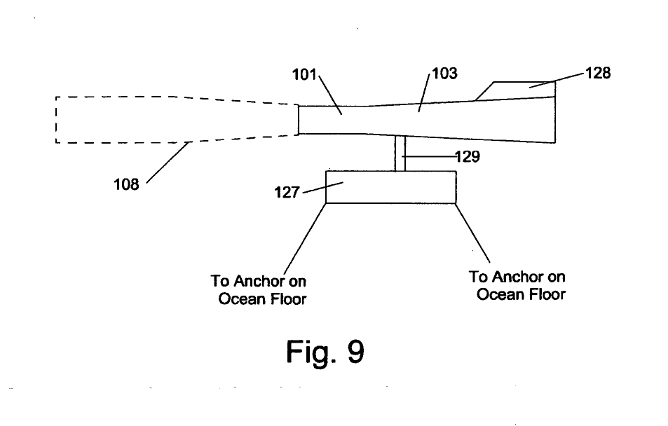

In an alternative embodiment, FIG. 9, the system may be fabricated on top of a floatation device (127) and mounted on a magnetic bearing mounted pivot (129) and placed in tidal flows. Fins (128) can turn the unit to align with tidal flows as they move first on one direction, and then the opposite. The central water tube (101), turbine (102), and exit cowling (103) system can be sized larger to produce extra power and the battery bank (115) can be made sufficiently large to allow for the generation of power during ebb tide transitional flow periods.

The low speed hydro powered electric generating system described herein can be built at a capita cost competitive with fossil fuel based generating systems and as such constitutes a significant improvement over existing systems.

In other embodiments, different power ratings ranging from 25 kilowatt to 1.5 megawatts or larger may be used, as well as different number of blades, different diameter turbines, different sizes of exit cowling, and different numbers of batteries of different voltages wired in different ways to produce different voltages and different levels of redundancy.

A DC motor to AC generator set can be used in lieu of the inverter bank, as well as other input/output voltages from the inverter bank.

An embodiment may be developed specifically for tidal flows.

The low speed hydro powered electric generating system described is a unique invention that offers a number of advantages.

Large amounts of power can be generated from rivers, ocean currents and tidal flows which are renewable resources. This system of providing renewable energy is not presently being used.

Rated power is available on demand, not subject to the vagaries of the weather. This is a major advantage relative to other forms of renewable energy.

Capital cost is low compared to all other forms of producing electric power.

This power is renewable and has no associated fuel cost.

The generation of electricity in this manner produces no emissions.

The only known environmental consequence of this system in a river is a slight rise in water level which will be less than with other referenced systems.

The DC to AC conversion system is proven and reliable in other applications and can easily be built to electric power company reliability standards.

The battery bank system described herein, together with the redundancy and monitoring constitutes a system that meets electric power company reliability standards.

The building of dams or other structures that increase the head pressure of a river system to a level required to produce usable power are not required, expensive and interfere with the normal water course.

The system is low in maintenance compared to all other forms of renewable resource generating electric equipment, and competitive with the maintenance costs of fossil fuel based systems.

The low speed hydro powered electrical generating system described herein is new, addressing certain specific needs of society, among them the need for electric power that is available on demand. It offers a number of advantages some of which are economy and a naturally renewable, non-polluting electric power source.

While the foregoing is directed to embodiments of the present invention, other and further embodiments of the invention may be devised without departing from the basic scope thereof, and the scope thereof is determined by the claims that follow.

We claim:

1. A low speed hydro powered electric generating system for use in rivers, ocean currents, and tidal flows comprising:
a power generating section including a radial turbine mounted inside a central water passage attached to a downstream exit cowling of expanding area towards the downstream side wherein the turbine is constructed and arranged to cause DC power to be produced; and
a power conversion section wherein the DC power is converted to AC power.

2. The low speed hydro powered electric generating system as in claim 1 wherein the cross sectional area of the exit cowling at the point of attachment to the central water tube is similar to the area of the central water tube and becomes greater moving downstream towards the exit point via outwardly angled plates so that the exit area is significantly greater than the turbine area.

3. The low speed hydro powered electric generating system as in claim 2 wherein the water flowing around the exit cowling is moving faster than the theoretical velocity of the water moving through the exit cowling creating a frictional interface across which momentum energy is transferred, accelerating the water flowing through the exit cowling, thus developing a suction from the downstream side that operates back into the exit cowling pulling water through the central water passage and across the turbine at a rate much faster than the flow of the stream of water itself.

4. The low speed hydro powered electric generating system as in claim 1 wherein the turbine has tiplets attached to the ends of the blades to which inductors are mounted to induce a DC current in a generating coil.

5. The low speed hydro powered electric generating system as in claim 1 wherein the turbine blades are contained within a ring to which inductors are mounted to induce a DC current in a generating coil.

6. The low speed hydro powered electric generating system as in claim 1 where screens can be placed across both the entry and the exit to prevent swimmers and wildlife from entering or being sucked into the system.

7. The low speed hydro powered electric generating system as in claim 1 for a ocean current embodiment wherein the system contains a floatation device sufficient to develop positive buoyancy and which is anchored to the ocean bottom in such fashion that the device is maintained sufficiently below the ocean surface to place it in the current and beneath the surface affects of the weather.

8. The low speed hydro powered electric generating system as in claim 1 for a tidal embodiment where the entire assembly can be mounted on a pivot which in turn is mounted on a floatation platform anchored to the bottom and wherein the exit cowling has fins added to orient the system with the direction of the tidal flow and wherein the system has sufficient energy storage developed during peak flow periods to allow the system to deliver rated power during ebb periods.

9. An electric generating system wherein a parallel axis radial turbine assembly spins inside of a central water passage and wherein the turbine is mounted within opposing rectangular magnetic bearings of sufficient strength so that the inconstancies of a rectangular magnet mounted on a curved surface are of no consequence.

10. An electric generating system wherein a DC power source of any kind is connected to a bank of solid state DC to AC inverters wherein the exact phase angle of each inverter may be communicated to and adjusted by a control computer for the purpose of coordinating the sine wave output of the several inverters so that they are all on phase together and further coordinating the sine wave output of the inverter bank to match the phase angle of the grid and where the condition of the inverters, the phase angle and other critical parameters are reported to a remote operator.

11. The electric generating system as in claim 10, comprising:
a weather tight housing;
a battery bank;
a voltage regulator system;
a solenoid system;
a DC to AC inverter bank; and
a computer control, monitoring and communication system wherein all of the critical components and parameters can be monitored by the computer and a remote operator automatically alerted in the event of problems.

12. The low speed hydro powered electric generating system as in claim 10 wherein a number of commercially available 12 volt batteries are wired in series into a battery unit so that substantially higher voltages are developed across the battery unit, and where several such units are then wired in parallel to provided voltage continuity in the event of a battery failure.

13. The low speed hydro powered electric generating system as in claim 10 where the individual batteries have continuity sensors monitored by a control computer for the purpose of detecting and notifying a remote operator that a battery has gone bad.

14. The low speed hydro powered electric generating system as in claim 10 wherein there is a redundancy of inverters so that in the event there is a problem with one or more, the operator may remotely switch it off without affecting the overall performance of the system.
